(19) United States
(12) Patent Application Publication
(10) Pub. No.: US 2003/0016285 A1
(43) Pub. Date: Jan. 23, 2003

(54) Imaging apparatus and method

(76) Inventors: Jeffrey D. Drost, Flanders, NJ (US); Bruce A. Pellegrino, Far Hills, NJ (US)

Correspondence Address: SYNNESTVEDT & LECHNER LLP, 1101 Market Street, 2600 Aramark Tower, Philadelphia, PA, 19107-2950, US

(21) Appl. No.: 10/135,865

(22) Filed: Apr. 30, 2002

Related U.S. Application Data
(60) Provisional application No. 60/287,429, filed on Apr. 30, 2001.

(51) Int. Cl. G06F 7/00

(52) U.S. Cl. 348/125; 701/29; 701/30

(57) ABSTRACT

An inspection system comprising: (a) a moveable inspection device comprising an imaging device and a range finder, the imaging device comprising a lens assembly which is adapted to define a particular field of view, and an optical converter for converting an image of an object captured within the particular field of view into image data and for transmitting the image data on an image signal, the range finder being adapted for determining the distance from the imaging device to a point within the particular field of view and for transmitting distance data on a range signal; (b) a base station communicatively coupled to the imaging device for receiving the image signal and the range signal, the base station having an image display device for displaying an image based on the image data; and (c) a measurement system comprising a processing unit which is configured to calculate measurement data corresponding to the dimensions of the object based upon the distance data and the field of view.

### REFERENCE TO RELATED APPLICATION

This application claims priority to provisional application No. 60/287,429, filed Apr. 30, 2001, and hereby incorporated by reference.

### FIELD OF INVENTION

The present invention relates generally to the inspection of areas which are uninhabitable or inaccessible by humans. More specifically, the invention relates to inspection systems capable of generating measurement data corresponding to the actual size of an imaged object.

### BACKGROUND OF INVENTION

Presently, electromechanical inspection devices such as pipe crawlers, video sticks, and push cameras are used to inspect areas which are physically unreachable by humans or contain environmental conditions unsuitable for humans. These inspection devices are especially useful for inspecting pipes and containment area and for identifying blockages and structural problems, such as cracks and fissures, which would otherwise be difficult and/or expensive to ascertain.

Generally, the inspection devices are equipped with a camera which is used to capture visual images in the vicinity of the inspection device. The visual images are displayed on a monitor located at a remote base station. By viewing the images, the operator can perform a visual inspection of the area around the inspection and can maneuver the inspection device through the pipes or containment to identify cracks and fissures which would not otherwise be detectable.

The inspection device is typically coupled to a base station. The base station comprises an operator's control for maneuvering the inspection device and for manipulating the camera thereon to change its orientation and to adjust its viewing area. The base station is typically coupled to the inspection device through a cable. The cable is used to transmit images from the camera to the base station and to transmit instructions and power from the base station to the imaging device.

After identifying a crack or fissure, it is often desirable to determine the size of the crack or fissure so that the extent of damage can be determined and an appropriate “fix” can be implemented. This determination, however, can be difficult, especially in a single point vision system. In single point vision systems, it is difficult to determine the size of an object due to the lack of depth perception. For example, an object which appears small on the monitor may be small or it may be far away from the camera. Therefore, to obtain meaningful measurements, the operator typically compares the object to a reference object with known dimensions within the field of view. For example, the operator can estimate the size of a crack based on the size of a rivet within the pipe. Although traditionally used, this method is imprecise. These measurements are especially prone to error if object being measured is much smaller or larger than the reference object, or if object being measured is not directly related to the reference object (e.g., the crack is not near the rivet). In addition to being imprecise, this approach is slow and requires experience to obtain meaningful results.

Therefore, there is a need for an inspection system and method that enables an operator to quickly and accurately determine the size of an object's features displayed on a monitor. The present invention fulfills this need among others.

### SUMMARY OF INVENTION

The present invention provides for an inspection system and method which overcome the aforementioned problems by generating measurement data of an object based on the distance of the object away from an imaging device and on the field of view of the imaging device. The measurement data are displayed preferably on a monitor along with the image of the object to enable an operator to quickly and accurately determine the actual size of the object.

One aspect of the present invention is an inspection system for obtaining the measurement data. In a preferred embodiment, the inspection system comprises: (a) a moveable inspection device comprising an imaging device and a range finder, the imaging device comprising a lens assembly which is adapted to define a particular field of view, and an optical converter for converting an image of an object captured within the particular field of view into image data and for transmitting the image data on an image signal, the range finder being adapted for determining the distance from the imaging device to a point within the particular field of view and for transmitting distance data on a range signal; (b) a base station communicatively coupled to the imaging device for receiving the image signal and the range signal, the base station having an image display device for displaying an image based on the image data; and (c) a measurement system comprising a processing unit which is configured to calculate measurement data corresponding to the dimensions of the object based upon the distance data and the field of view.

Another aspect of the invention is a method for providing measurement data of an object in a field of view. In a preferred embodiment, the method comprises the steps of (a) imaging an object in a particular field of view using an inspection device; (b) determining the distance between the inspection device and the object; (c) calculating measurement data corresponding to the dimensions of the object based upon the distance and the field of view; and (d) displaying an image of the object on a display device and providing the measurement data to an operator to enable the operator to ascertain the dimensions of the object.

### BRIEF DESCRIPTION OF DRAWINGS

FIG. 1 is a block diagram of a scaled imaging apparatus in accordance with the present invention;

FIG. 2 is a flow diagram illustrating the process of capturing information related to an object, generating a scale for the object, and displaying the scale on a monitor in accordance with the present invention;

FIG. 3 is a block diagram illustrating, in detail, the calculation of the scaling information in accordance with the present invention;

FIGS. 4a-4d are pictorial diagrams illustrating the presentation of scaling information determined using the steps of the flow diagram in FIG. 2 in accordance with the present invention; and

FIGS. 5a and 5b illustrate an approach for determining the scale of an object which is skewed from the field of view of the lens assembly.

### DETAILED DESCRIPTION OF INVENTION

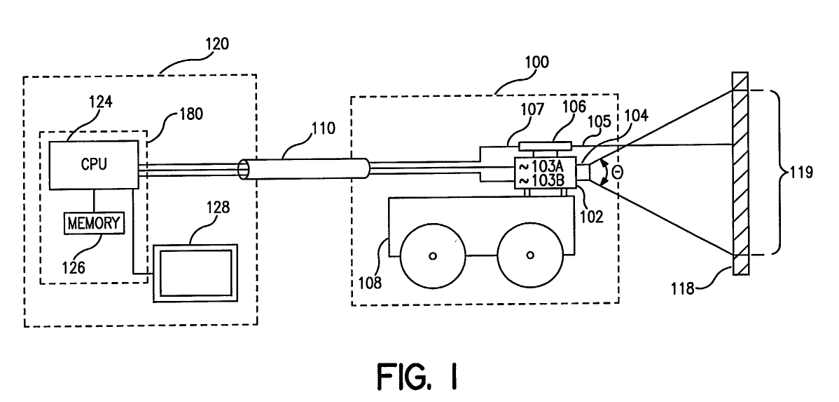

FIG. 1 shows an inspection system of the present invention. In general, the system comprises a positionable or moveable inspection device 100, a base station 120, and a measuring system 180.

The inspection device 100 comprises an imaging device 102 and a range finder 106. The imaging device 102, in turn, comprises a lens assembly 104 which has an optical axis and a particular field of view perpendicular to the axis. The imaging device also has an optical converter (not shown) for converting an image of an object captured within the particular field of view into image data and for transmitting the image data in an image signal. The range finder 106 is adapted for determining the distance from the imaging device to a point within the particular field of view and for transmitting distance data in a range signal.

The base station 120 is communicatively coupled to the inspection device 100 for receiving the image signal and the range signal. The base station has an image display device 128 for displaying an image based on the image data and for providing the operator with distance data calculated by the measuring system.

The measurement system 180 has a processing unit 124 which is configured to calculate measurement data corresponding to the dimensions of the object based at least upon the distance data and the particular field of view. The measurement data are provided to the operator via the base station.

It should be understood that the division of the system into three components is for illustrative purposes and should not be construed to limit the scope of the invention. Indeed, the various components may be further divided into subcomponents, or the various components and functions may be combined and integrated. A detailed discussion of the various components and features of the inspection system follows.

### Inspection Device

The inspection device 100 is configured to access areas which are otherwise inaccessible to humans or have conditions which render them uninhabitable. These conditions may include, for example, small confined spaces, lack of air/oxygen, presence of toxins, radioactivity, contamination, excessive dust, dirt and filth, and high noise levels. These conditions can be found in areas common to storm and sewer pipes, nuclear reactors and containments, fossil fuel plants and petrochemical refining facilities just to name a few.

As shown in FIG. 1, the inspection device 100 comprises a moveable platform 108 which is self propelled and controllable using the operator's control at the base station. The depicted inspection device is commercially available as the ROVVER Robotic Crawler™ through EverestVIT (Flanders, NJ). Alternatively, the inspection device may comprise a push camera to facilitate inspection of pipes, or a camera on a pole to facilitate inspection of hard-to-reach locations (e.g., the QuickView™ inspection system, EverestVIT). In yet another embodiment, the inspection device may comprise a remotely operated, portable device which is placed in the area to be inspected and then controlled remotely (e.g., the SuperZoom™ inspection system, EverestVIT). Preferably, but not necessarily, the inspection device is designed to operate remotely from the base station.

The inspection device comprises an imaging device 102, the principal function of which is to provide imaging information. To this end, the imaging device comprises an image converter (not shown) for converting an image of an object 118 in the field of view 119 to an image signal which is preferably an electronic signal transmitted on a conduit 103A. Suitable image converters include circuitry for converting both moving and still images in either an analog or digital format. In the preferred embodiment, the image converter provides a video image of the target area. More preferable, the image converter comprises a charge coupled device (CCD) which is well known in the art. The CCD electronically captures an image of the video field in an analog format and the analog information is relayed to the monitor/digital recording functionality of the base station in the image signal.

The imaging device also comprises the lens assembly which defines the field of view 119 for capturing an image of object 118. The lens assembly has optical characteristics such as focal length, field of view, and projection angle θ, which may be used in the calculation of the object size as described below. These optical characteristics are herein referred to as “field of view data.” In a preferred embodiment, the lens assembly 104 is adjustable to alter the size of the field of view 119 and thereby change the projection angle θ. An adjustable lens assembly typically comprises a series of lenses (not shown) which interact to change the focus, magnification and field of view. A suitable imaging device having the above-mentioned magnification and functionality is commercially available from, for example, Sony Company (Model No. FCB-IX47).

As is known in the art, the adjustable lens assembly preferably includes a servo system of motors and associated circuitry for manipulating the position of the various individual lenses in relation to each other and in relation to the image converter in order to effect different foci and magnification configurations. The servo system is responsive to a lens control signal generated by the operator's control. The system also generates a lens position signal that corresponds at least to the relative position of two or more lenses to effect a particular field of view. The lens position signal has traditionally been used as feedback for the servo system, but in a preferred embodiment of the present invention, the inspection system also utilizes this lens position signal to calculate the field of view or related optical measurement (e.g., projection angle θ). Accordingly, the lens position signal is transmitted to the base station preferably via a conductor 103B.

Preferably, the imaging device is mounted on a Pan-Tilt-Zoom (PTZ) mechanism. In a typical PTZ mechanism, the orientation of the camera and the zoom of lenses can be controlled by the operator from the base station 120.

The range finder 106 of the inspection device is used to measure the distance between the imaging device 102 and the object 118. Preferably, the range finder 106 uses a beam 105 to determine the distance to the object 118. In the preferred embodiment, the beam 105 is a laser beam which produces a visual spot on the object 118, thereby providing visual confirmation to the operator of the point to which the beam is measuring. The object 118 reflects the beam 105 back to a photo-detector on the range finder 106 where the reflected beam is detected. The time delay between sending the beam and detecting the reflected beam is processed by circuitry within the range finder 106 (e.g., a detector and time delay circuitry) to determine the distance between the range finder 106 and the object 118. Alternatively, the range finder 106 may incorporate sonic pulses or other conventional distance measuring technique. The range finder 106 generates a measurement signal which corresponds to the distance between the range finder 106 and the object 118. The measurement signal then is transmitted along conduit 107 to the base station 120. An example of a suitable range finder 106 is the DATA DISTO™ RS232 available through Leica AG, although other types of range finders will be readily apparent to those in the art.

In a preferred embodiment, the range fiber is actuatable such that the beam can be directed to specific points within the field of view. In such an embodiment, the range finder is mounted to an actuatable platform such as a pan and tilt mechanism. The actuatable platform moves in response to a beam control signal generated by the operator's control at the base station. It is important that the operator know the relative position of the beam in the field of view, and, thus, it is preferred that the actuatable platform transmit a beam position signal to the base station. The beam position signal preferably provides data of the beam's angle a with respect to the optical axis of the lens assembly 104. The generation of a beam position signal may be accomplished using traditional apparatus such as a resolver or an encoder.

### Base Station

The principal function of the base station is to provide the operator with means of controlling the inspection device and for viewing/recording the images transmitted by the imaging device. To this end, the base station must be communicatively connected to the inspection device to transmit and receive signals such as the lens control signal, the lens position signal, the measurement signal, the beam control signal and the beam position signal, plus any other control signals used to control the movement of the platform 108 and the power required for the inspection device 100. This connection may be a conductive cable or a wireless link. In a preferred embodiment, a cable 110 is used which contains the conductors 103A, 103B and 107, and which is enveloped by a flexible sheath such as a polyurethane jacket. In alternative embodiments, the cable 110 is enveloped by or contains a semi-rigid or rigid material for transferring forces and/or supplying support from the base station 120 to the moveable platform 108. Yet in another embodiment, the base station is integral with the imaging device such as with the QuickView™ inspection device available through EverestVIT.

The operator views the images being transmitted by the imaging device using an image display device 128, such as a conventional monitor. As is well known, the monitor 128 has a display which is made up of individually addressable pixels.

The operator controls the movable inspection device using an operator's control. In a preferred embodiment in which the inspection device is mobile, the operator's control comprises a joy stick which allows the operator to control the direction of the inspection device while viewing the displayed image 119a on the monitor. Preferably, the field of view and magnification of the lens assembly 104 is adjustable and is controlled by a switch or knob as is well known in the art. The position of the imaging device and the range finder (e.g., pan and tilt) may also be controllable and therefore may require a joystick or similar device to generate control signals. Finally, the operator's control may contain other functionality to query or otherwise interact with the measurement system as described below.

### Measurement System

The measurement system functions to provide the operator with a measurement of an object in the field of view or with means of measuring the object. The measurement system comprising a processing unit 124 which contains programming instructions for determining measurement data based on the distance data received from the inspection device and the field of view. Herein, when reference is made to calculating measurement data based on the field of view, it should be understood that such a calculation may use any parameter corresponding to a particular field of view, such as projection angle θ and focal length. If the lens assembly is fixed and the field of view thus constant, information relating to the field of view may be stored in memory 126. Preferably, however, the lens assembly is adjustable such that the field of view changes as a function of the lens position. In such a preferred embodiment, information relating to the field of view is calculated based on the lens position signal. The correlation between lens position and field of view is known in the art and can be established by a mathematical relationship or by empirical calibration.

The processing unit may be any data processing machine such a processor, state-machine, digital signal processor (DSP), application specific integrated circuit (ASIC), or any conventional processing system capable of executing instructions and any combination of one more of the aforementioned. The processor unit may be integral to or discrete from other processors of the inspection system, such as, for example, the processor for the video signal and/or operator's control. Furthermore, the processor may be located in the base station, in the inspection device, or in a discrete housing.

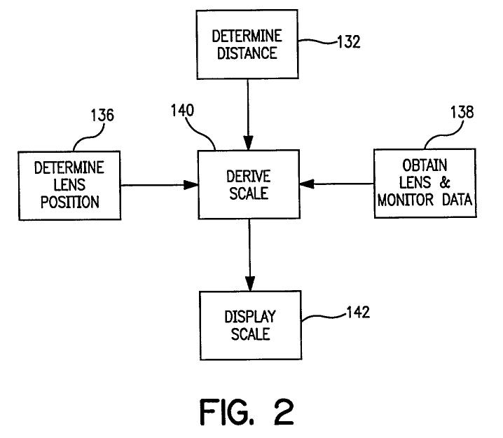

By performing the steps set forth in FIG. 2, the scaled imaging apparatus of FIG. 1 is able to generate a scale for a visual image of an object 118 for display on the monitor 128. For illustrative purposes, the feature for which a scale will be determined is the distance between a point A and a point B of a crack 116 within the object 118.

In step 132, the distance from the imaging device 102 to an object 118 displayed on the monitor 128 is determined. The range finder 106 generates a beam 105 which strikes the object 118 and is reflected. The range finder 106 receives the reflected beam and processes it to generate a range signal 107 which corresponds to the distance between the imaging device 102 and the object 118. Preferably, the output of the range finder 106 is located near the lens assembly 104 of the imaging device 102, thereby directly providing the distance between the imaging device 102 and the object 118. Alternatively, the range finder 106 may be offset from the lens assembly 104 of the imaging device 102 and the difference in position can be accommodated by the processing unit 124 or by calibrating the range finder 106.

In a simple embodiment, the beam is positioned to strike an object in a fixed position in the field of view, preferably, perpendicular to the field of view. Such a configuration lends itself to relatively simple calculations to determine the dimensions of the field of view as discussed below. In more sophisticated embodiments, the beam can be directed by the user to strike one or more variable positions in the field of view. In such an embodiment, the beam position signal which relates to the beam's angle α with respect to the optical axis, is transmitted by the actuatable platform and received by the processor unit. Typically, if the beam is fixed and perpendicular to the field of view, angle α will be around 0 (i.e., the beam is essentially parallel to the optical axis) and therefore is negligible. However, if multiple strike points are used within the field of view, then it is likely that the angles α_{1 . . . n} will be significant in calculating the measurement data for the field of view.

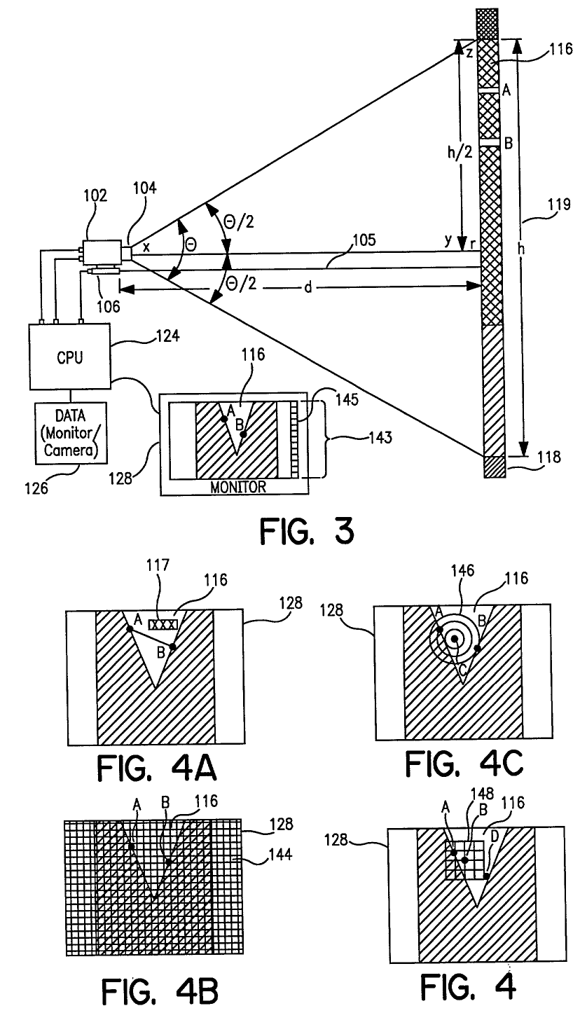

In step 136, lens position data which correspond to the field of view are received from the imaging device 102. Alternatively, if the lens assembly is fixed, the information for the fixed field of view may be stored in the memory 126. In step 140, the processing unit 124 derives a scale or measurement for a visual image of the object 118 displayed on the monitor 128. To this end, the processor first computes the actual size of the field of view as a function of at least the distance D and the field of view data from the lens system. In a simple embodiment, where the position of the laser strike in the field of view is fixed and perpendicular to the field of view (i.e., angle αis 0), this function is simple and is described for illustrative purposes with respect to FIG. 3. The processing unit 124 divides the projection angle θ by two to determine a near angle θ/2 of a right triangle XYZ. Using an inverse tangential function, the processing unit 124 is able to determine the apparent height of half of the field of view 119 (i.e., the far side YZ of the right triangle XYZ). Next, using the magnification obtained from the imaging device 102, the processing unit 124 determines the actual height of half of the field of view 119. Then, by multiplying by two, the processing unit 124 is able to obtain the actual height of the field of view 119. Other means for calculating the horizontal and vertical distances of the field of view based on the distance D, angle α, and θ-related data will be apparent to those skilled in the art without departing from the spirit of the present invention. In particular, different trigonometric functions can be used to relate the dimensions of the field of view to the distance D, angle α, and angle θ. For example, if the distance measurement is not made normal to the field of view, i.e., angle α≠0, it may be preferable to use the Law of Cosines, rather than the Pythagorean theorem.

The embodiment described above is preferred from a simplicity standpoint and is optimal if the object being viewed is substantially in the plane of the field of view, i.e. perpendicular to the optic axis of the lens assembly. However, if the object being viewed is askew to the field of view or if there are several objects in the field for which dimensional information is desired, then it may be preferred to use a more sophisticated embodiment of the invention in which multiple distances D_{1 . . . n} are determined at different strike points in the field of view as mentioned above.

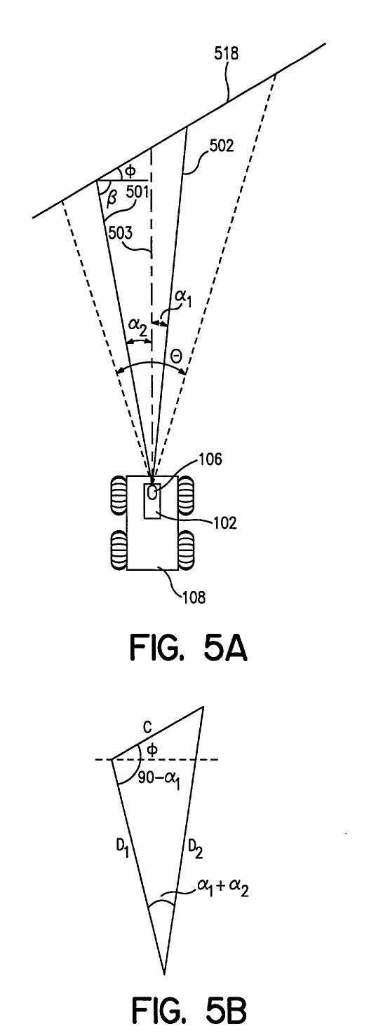

An approach for generating a scale for an object which is askew to the field of view is shown schematically in FIGS. 5a and 5b. In FIG. 5a, a top view of the inspection device 101 of FIG. 1 is shown with an object 518 in the field of view of lens system 102. As is the convention herein, the field of view has a projection angle θ. Unlike previously-considered situations, however, the object 518 is not perpendicular to the optical axis of the lens system, but rather at an angle φ from the plane of the field of view. To compensate skewing, the angle φ must first be determined. To this end, the beam of the range finder 106 is directed to take two distance measurements 501, 502 are taken to determine distances D₁ and D₂, respectively. Beams 501 and 502 are at angles α₁, and α₂, respectively, from the optical axis 503 of the lens assembly.

Referring to FIG. 5b the geometry of the field of view and distance measurements in FIG. 5a are extracted and simplified. By knowing D₁, D₂, α₁, and α₂, φ can be determined. One approach for determining (p uses the Law of Cosines as follows:

C²=D₁²+D₂²−2D₁D₂ cos (α₁+α₂) Equation (1)

For example, if D₁=2 m, D₂=3 m, α₁=12.44° and α₂=8.35°, C=1.33 m. Once distance C is determined, then the angle φ+β can be determined also using a derivation of the Law of Cosines as follows:

φ+β=cos⁻¹−( (D₂²−C²−D₁²)/2D₁C) Equation (2)

Using the same example as above, φ+β=127.07°. Angle β is easily determined as follows given the fact that the angles of a triangle total 180°:

β=90−α₁ Equation (3)

Accordingly, β=77.56°. By subtracting β from φ+β of Equation 2, φ can be determined. Thus, in the present example, φ=49.51°.

The example above and the illustration in FIG. 5a and 5b considered a plane of an object that was aligned with the vertical axis (y axis) but askew in the horizontal and depth axises (x and z axises respectively). It should be understood, however, that the same concepts can be applied to a plane askew with respect to all three axis. Indeed, it is well known in geometry, that if three points are measured on a plane of an object in the field of view, then the angular relationship of the object's plane with respect to the field of view can be determined.

After determining the dimensions of the field of view 119 and skew, if any, the processing unit 124 determines the appropriate scale, which may be displayed on the monitor or it may be used internally to provide a measurement between selected points in the field of view 119. The scale relates the field of view 119 with the displayed image 119a. In a simple embodiment, this scale is a ratio of a dimension of the field of view over the corresponding dimension in the displayed image. For example, after obtaining the actual height of the field of view 119, the processing unit 124 may divide the actual height of the field of view 119 by the number of vertical pixels 143 used by the monitor 128. Through this calculation, the processing unit 124 determines the vertical distance represented by an individual pixel 145 of the monitor 128. Although simple, this scaling approach ignores the skew of the object to the field of view, lens distortion, and pixels having an aspect ratio other than one. In a preferred embodiment, these factors are considered in the scale.

If the object is skewed with respect to the field of view, then the scale should be adjusted along the axis (or axises) in which the skew exists. For example, referring to FIG. 5a, the scale for object 518 needs to be adjusted to compensate for skew along the horizontal axis. To this end, the scale preferably is increased by a factor of tan φ along the horizontal axis. Therefore, in the example above, where φ is 49.51°, the scale along the horizontal dimension of the field of view would be increased by 1.17 (tan 49.51°) to compensate for the skew of the object with respect to the field of view. Similar adjustments can be made with respect to the skew along the vertical axis.

In a preferred embodiment, the scale is adjusted not only for skew but also for optical distortion and pixels having an aspect ratio other than one. It is well known that a lens will introduce a certain amount of distortion to an image, particularly along the periphery of the lens where the image suffers from “fish-eye.” This situation is especially pronounced if a wide-angle lens is used. In addition to lens distortion, pixels are not always circular or square, but rather can be elongated and have an aspect ratio. For example, in the case of a rectangular pixel, the distance it represents along one axis will be different from the distance it represents along another axis. A preferred approach for compensating for lens distortion and rectangular pixels is disclosed in U.S. Pat. No. 5,070,401, which has a common assignee with the present invention and which is hereby incorporated by reference.

Accordingly, in a preferred embodiment, the process of the present invention involves a step 138, in which the characteristics relating to the monitor 128 and lens assembly 102 are retrieved by the processing unit 124. The characteristics contain information related to the monitor 128 such as the number of vertical or horizontal pixels and the aspect ratio of the pixels, and information related to the lens system such as correlations of the lens position signal to the field of view and lens distortion data. These characteristics are preferably stored in the memory 126.

At step 142, the scale determined by the processing unit 124 is displayed on the monitor 128 using known techniques. Alternatively, the measurement data need not consider the parameters of the monitor and instead may provide a measurement value or scale based on the measurement of the field of view, independent of the monitor.

FIGS. 4A-4D depict ways in which the scale information can be used to determine the size of a crack 116 within the object 118 displayed on a monitor 128. The size of the crack is determined by determining the distance between point A and point B of the crack 116 within object 118. Points A and B are selected by the operator using a keypad or mouse which is preferably part of the operator's control. FIG. 4A depicts a monitor 128 in which a first point, point A is selected and then a second point, point B, is selected, and a numerical display 117 on the monitor 128 indicates the distance between point A and point B. In a preferred embodiment, the numerical display 117 will repeatedly update as the second point changes position.

In FIG. 4B a grid 144 representing the scale is overlaid on the entire viewable area of the monitor 128. The distance between point A and point B can then be determined visually by the operator. In FIG. 4C, a circular grid 146 is displayed on the object 118 with each grid line representing a scaled distance in response to an operator selecting a point C on the object 118 with a pointing device. The grid 146 can be moved by moving the selection point C. In FIG. 4D a square grid 148 is displayed when a point D is selected by the operator. As in the embodiment depicted in FIG. 4C, the grid 148 can be moved by moving the selection point D. Alternative embodiments for depicting the scaling information generated by the processing unit 124 and displayed on the monitor 128 will be readily apparent to those skilled in the art.

In addition to the linear size of an object, the area of an object can be also calculated. For example, the area of a generally square shaped object could be determined by marking the four corners of the object, determining the distance encompassed by the four corners using the method discussed above, and then applying the appropriate geometrical formula. Alternatively, the user may outline the object in question using the cursor and then the processor unit may calculate area of the circumscribed object automatically.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. An inspection system comprising:
a moveable inspection device comprising an imaging device and a range finder, said imaging device comprising a lens assembly which is adapted to define a particular field of view, and an optical converter for converting an image of an object captured within said particular field of view into image data and for generating an image signal corresponding to said image data, said range finder being adapted for determining the distance from said imaging device to a point within said particular field of view and for generating a range signal base on said distance data;
a base station communicatively coupled to said imaging device for receiving said image signal and said range signal, said base station having an image display device having a display for displaying an image based on said image data; and
a measurement system comprising a processing unit which is configured to calculate measurement data corresponding to the dimensions of said object based upon said distance data and said particular field of view.

2. The inspection system of claim 1, wherein said lens assembly has servo circuitry for adjusting the relative position of two or more lenses within said lens assembly to alter the field of view, said servo circuitry being responsive to a lens control signal and providing a lens position signal corresponding to said relative position of two or more lenses; wherein said base station has an operator's control device for transmitting said lens control signal; and wherein a processor is configured for calculating a projection angle based upon said lens position signal.

3. The inspection system of claim 2, wherein said processing unit comprises said processor.

4. The inspection system of claim 1, wherein said measurement data corresponds to a scale displayed with said image on said display.

5. The inspection system of claim 4, wherein said measurement data corresponds to a grid displayed on at least a portion of said display, wherein lines on said grid depict said scale.

6. The inspection system of claim 5, wherein said scale is a value based upon the relative sizes of the field of view and the display device.

7. The inspection system of claim 6, wherein said value is calculated based upon the number of pixels along one or more dimensions of said display.

8. The inspection system of claim 1, wherein said measurement data corresponds to a numerical value, said value corresponding to the distance on said object between a first operator-selected point on said image and a second operator-selected point on said image.

9. The inspection system of claim 1, wherein said measurement system is a component of said base station.

10. The inspection system of claim 1, wherein said processing unit is common to a processor used to process said image signal.

11. The inspection system of claim 1, wherein said range finder comprises:
a laser for generating a beam;
a receiver for receiving a reflection of said beam; and
a time delay circuit coupled to said laser and said receiver for determining the delay between said laser emitting said beam and said receiver receiving said reflection of said beam.

12. The inspection system of claim 11, wherein said range finder is substantially close to said lens assembly.

13. The inspection system of claim 11, wherein said processing unit adjusts for offset between said range finder and said lens assembly.

14. The inspection system of claim 1, range finder comprises an actuatable platform to direct a beam of the range finer at variable points within said field of view, said actuatable platform generating a beam position signal relating to the beam's position within the field of view.

15. A method for providing measurement data with a displayed image, said method comprising the steps of:
(a) imaging an object in a field of view having a projection angle using an inspection system;
(b) determining the distance between said inspection system and said object;
(c) calculating measurement data corresponding to the dimensions of said object based upon said distance and said projection angle; and
(d) displaying an image of said object on a display device and providing said measurement data to an operator to enable the operator to ascertain the dimensions of said object.

16. The method of claim 15, further comprising:
calculating a projection angle based upon the relative position of two or more lenses within a lens assembly of said inspection system.

17. The method of claim 15, wherein said measurement data is a scale and step (d) comprises displaying said scale along with said object.

18. The method of claim 15, wherein step (d) comprises overlaying a grid on at least a portion of said image wherein the lines of said grid are scaled.

19. The method of claim 15, wherein step (c) further comprising:
selecting a first point on said image;
selecting a second point on said image; and
calculating the distance between points on said object corresponding to said first and said second points on said image.

20. The method of claim 15, wherein said measurement data is based upon a relationship between the dimensions of said display device or portion thereof and said field of view.

21. The method of claim 15, wherein said measurement data is at least one of linear measurement data, area measurement data, or volume measurement data.

22. The method of 15, further comprising calculating skew of said object within said field of view and compensating said measurement data based upon said skew.

23. A moveable imaging device comprising:
an imaging device comprising a lens assembly which is adapted to define a particular field of view, said lens assembly comprising servo circuitry for adjusting the relative position of two or more lenses within said lens assembly, thereby adjusting the field of view and thus said projection angle, said servo circuitry being responsive to a lens control signal and providing a lens position signal corresponding to said relative position of two or more lenses;
an optical converter for converting an image of an object captured within said particular field of view into image data and for transmitting said image data on an image signal; and
a range finder being adapted for determining the distance from said imaging device to a point within said particular field of view and for transmitting distance data on a range signal.

24. The device of claim 23, wherein said base is configured for use with a robotic crawler.
